(19) United States
(12) Patent Application Publication
(10) Pub. No.: US 2010/0180822 A1
(43) Pub. Date: Jul. 22, 2010

(54) MILKING SYSTEM

(75) Inventor: Jonas Holmqvist, Stockholm (SE)

Correspondence Address: YOUNG & THOMPSON, 209 Madison Street, Suite 500, Alexandria, VA, 22314, US

(73) Assignee: DELAVAL HOLDING AB, Tumba (SE)

(21) Appl. No.: 12/665,545

(22) PCT Filed: May 28, 2008
(86) PCT No.: PCT/SE08/50627

§ 371 Date: Dec. 18, 2009

(30) Foreign Application Priority Data
Jun. 18, 2007 (SE) 0701483-0

(51) Int. Cl. A01J 5/04; A01J 3/00

(52) U.S. Cl. 119/14.2; 119/14.46; 119/14.51

(57) ABSTRACT

A milking system for extracting milk from milk producing animals and especially with elements for taking samples of the extracted milk includes in a flow direction from the animal: milk extracting elements for attachment to the animal, a milk conduit and a suction source, wherein the suction source is arranged to provide a vacuum to draw milk from the animal to a container. The milk extracting elements are adapted to provide air and milk intermittently into the milk conduit and are connected to the container via the milk conduit. The system also includes a milk sample conduit which is connected to the milk conduit. The milk conduit includes a bend for creating acceleration forces in the flow, and the sample conduit is connected to the milk conduit at the bend so as to sample milk subjected to the acceleration forces.

### FIELD OF INVENTION

The present invention relates generally to milking systems for extracting milk from milk producing animals and especially to milking systems with means for taking samples of the extracted milk.

### BACKGROUND

Milk is a food product and it is important that it is safe for consumption and that it, for example, does not comprise harmful micro organisms. To protect the consumer and monitor udder health of cows, somatic cell count (SCC) of raw milk is commonly performed. This process discovers inflammations, since during an inflammation of a cow in its udder (mastitis) the number of somatic cells in its milk rises due to the reaction of cellular immune defence against the injury. Since the number of somatic cells varies considerably throughout a milking process, it is advantageous to take out a sample that is representative of the whole milking.

An example of sampling milk is to pump out a small amount of milk from an end unit. The milk sample is lead into a cell counter and a reagent is mixed into the milk, and thereafter an optical cell counting instrument provides the cell count value.

Another example is to sample milk from a milk conduit. In this context, an example of an outlet that gives a representative sample is a knife outlet. The knife is a small out scooped pod that is inserted into a vertical down going milk conduit. During milking, a small amount of the milk collects in the pod and is lead out of the conduit and into a sample vessel. A drawback with a knife outlet is that, since the pod is present in the milk stream, there is a risk of contamination due to collection of milk residues on it. Also, the pod disturbs the flow and might create free fatty acids (FFA) in the milk.

A less complicated outlet that does not disturb the flow is a branch or T-outlet. It can, for example (see FIG. 3), be mounted in a horizontal pipe 22 and directed downwards, so that it 23 provides a vertical withdrawal from the horizontal milk flow. Since there are no parts present in the flow, less milk residues will remain at the outlet. A disadvantage with this type of outlet 23 is that the sample rate varies with the flow rate so it is not as representative of the whole milking sequence as the knife outlet.

The above-described drawbacks and deficiencies of the prior art are overcome or alleviated by a milking system in accordance with the invention.

### SUMMARY OF THE INVENTION

For this purpose, the invention provides a milking system for extracting milk from an animal and transferring the milk to a container, comprising in a flow direction from the animal: milk extracting means for attachment to the animal, a milk conduit, and a suction source. The suction source is arranged to provide a vacuum to draw milk from the animal to the container, and the milk extracting means is adapted to provide air and milk intermittently into the milk conduit and is connected to the container via the milk conduit. The system also comprises a milk sample conduit. The milk conduit comprises a bend for creating acceleration forces in the flow, and the sample conduit is connected to the milk conduit at the bend so as to sample milk subjected to the acceleration forces.

In a further embodiment, the milking system comprises milk slug creating means in the flow direction before the bend of the milk conduit. By having dedicated means for providing slugs of milk, the production of slugs becomes reliable. Preferably, these slug creating means are in a simple reliable construction constituted by a bended conduit. Also preferably, the slug creating means is arranged directly before the bend of the milk conduit, so that the slugs run less risk of deterioration and collapse.

In a further embodiment, the sample conduit is directed downwards, providing an outlet for sampled milk from the milk conduit, where the sample conduit is directed downwards relative to a horizontal at the inlet of the sample conduit. This prevents sampled milk from returning to the milk conduit.

In a further embodiment, the inlet of the sample conduit is choked, which also prevents sampled milk from returning to the milk conduit.

In a further embodiment, the milk conduit is bent in a vertical plane so that the milk flow passes through a highest positioned top portion of the bend and continues to a lower positioned end portion of the bend. In this way there is less risk of contamination due to milk residues getting caught in the bent conduit and sample conduit inlet. Preferably, the sample conduit is positioned between the top portion and the end portion of the bend in the milk conduit.

In a further embodiment, the milk conduit is fixed so that it does not move when the animal moves.

In a further embodiment, the sample conduit is connected to a suction source and is arranged to draw milk samples from the milk conduit. In this way the suction in the sample conduit can balance the suction in the milk conduit.

In a further embodiment, the milk conduit is tapered, in the bend, in the flow direction, providing a passageway with a decreasing cross-section.

### BRIEF DESCRIPTION OF DRAWINGS

The invention is now described, by way of example, with reference to the accompanying drawings, in which:

FIG. 1 schematically illustrates a milking system in accordance with the invention,

FIG. 2 is a side view illustrating in greater detail a slug creating portion and the bent portion of the milk conduit of FIG. 1, and

FIG. 3 illustrates a branch or T-outlet in a horizontal pipe in accordance with the prior art.

### DETAILED DESCRIPTION OF PREFERRED EMBODIMENTS

In the following a detailed description of a preferred embodiment of the present invention will be given.

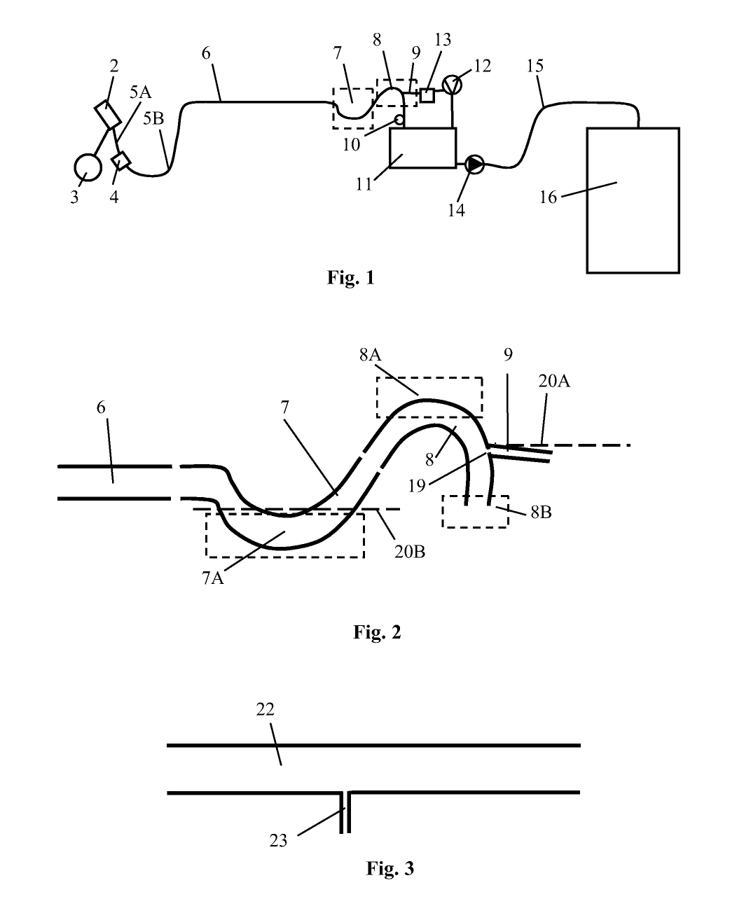

FIG. 1 illustrates a milking system in accordance with the invention. It includes milk extracting means 2, 3 and 4 for attachment to the teats of an animal. The extracting means comprises a pulsator 3 and a teat cup 2, providing pulsations to the teats by means of the operatively connected pulsator 3, and a mouth piece 4 with an air inlet. The milk extracting means 2, 3 and 4 are, in a known manner, adapted to provide milk intermittently in squirts into a milk conduit 5, 6, 7, 8 at the same time as a vacuum source 12 provides a vacuum drawing the milk from the animal. The milk conduit comprises a movable and flexible milk tube 5 connected to a fixed rigid pipe 6. The milk tube 5 is attached to the teat cups, and the mouthpiece 4 with the air inlet divides the milk tube into two parts 5A, 5B, where the shorter part 5A is closest to the teat cup 2, and the longer part 5B is positioned between the mouthpiece and the other parts of the milk conduit 6, 7, 8.

The rigid pipe 6 is horizontally mounted and is fixed so that it does not move if an attached animal moves, whereas the milk tube 5 and the milk extracting means 2, 3, 4 can move when the animal moves. The milk conduit further includes a slug creating portion 7 and a bent portion 8 with sampling outlet 9, and is connected to an end unit or container 11 to which the vacuum source 12 provides a suction. The slug creating portion 7 and the bent portion 8 of the milk conduit are also fixed.

For clarity, only one teat cup is shown, but preferably one teat cup will be provided for every teat of the animal, and preferably also one unit for every teat of every part between the animal and the container 11. In this way milk from the different teats is kept separated and if only one teat is infected this can be more easily detected, since the milk from different teats is not blended before being analyzed. It is also possible to have one container 11 for each teat, or at least one compartment in the container 11 for milk from each teat. In this way it is also possible to discard only the milk from the infected teat.

As will be explained, the function of the sampling outlet 9 is better if the milk is supplied in well defined slugs. The milk extracting means 2, 3, 4 in the milking system in FIG. 1 provides the milk intermittently but to achieve better slugs a slug creating portion 7 is preferably arranged (as in FIG. 1) immediately before the bent portion 8 with the sampling outlet 9. The flexible milk tube 5 comprises vertical bends and also provides slugs. Thus, in addition to the milk extracting means 2, 3, 4, the milking conduit 5, 6, 7, 8 comprises two different means for creating slugs: the movable milking tube 5 and the fixed slug creating portion 7. Since the milking tube 5 is moveable it is not as reliable for slug creation as a fixed part is. Also, since being arranged at a distance from the sampling outlet, the created slugs run the risk of collapsing before reaching the sampling outlet. Therefore, the slug creating portion 7 of the milk conduit is preferred, but not necessary, for providing milk slugs suitable for sampling through the sample outlet 9.

During milking the vacuum source 12 provides suction vacuum via the milk container 11 and the milk conduit 5, 6, 7, 8 to the teat cup 2 in order to draw milk from the animal. The pulsator 3 alternately provides vacuum and atmospheric pressure to the pulsating chamber between the liner and the housing of the teat cup 2, consequently the teat cup is sucking and massaging the teat so that milk is extracted, and the mouthpiece provides atmospheric air into the milk conduit 5 by means of its air inlet so that air and milk is drawn through the milk conduit 5, 6, 7, 8 to the milk container.

FIG. 1 also illustrates a sampling container 13 connected to the sample outlet 9 and a flow meter 10 arranged between the bent portion 8 and the milk container 11. The vacuum unit 12, or a separate vacuum unit, provides a vacuum to draw milk samples through the sample conduit 8 to the sampling container 13. A milk pump 14 is arranged at the milk container in a milk line 15 for pumping milk from the milk container to a milk tank 16 via the milk line 15. The milk container 11 and milk pump 14 can be arranged so that milk from different compartments comprising milk from different teats is lead to the same pump 14 and pumped via the same milk line 15 to the milk cooling tank.

In a milking parlor several milking stations extracting milk and transferring it to milk containers 11 can be provided, from which containers the milk is pumped by respective pumps 14 to a common milk bulk tank 16, via respective and/or common milk lines 15. The milk bulk tank 16 is preferably equipped with means for cooling the milk.

FIG. 2 illustrates in greater detail the part of the milk conduit comprising the slug creating portion 7 and the bend 8 with the sampling outlet 9. For the purpose of clarity the figure shows schematically the milk conduit portions as separated parts: the fixed horizontal pipe 6, the slug creating portion 7 and the bent portion 8 with the sampling outlet 9.

The slug creating portion 7 is connected to the horizontal pipe or conduit 6 and comprises a U-shaped lowered bent portion in the vertical plane providing a portion where milk is collected. The lowered bent portion 7A of the slug creating portion 7 is positioned entirely below the horizontal conduit 6, which is illustrated in the figure by the horizontal line 20B. When milk fills up the bend, air gets trapped before the bend. The pressure difference between the air from the atmospheric air inlet in the mouthpiece 4 (see FIG. 1) behind the milk and the suction provided by the vacuum source 12 in front of the milk, creates a column or slug of milk rushing through the conduit in a known manner.

These columns of milk are often called slugs or slabs. Sometimes they are called slugs when travelling in a horizontal direction and “plugs” when travelling in a vertical direction. Regardless of travelling direction, these milk columns are in this description referred to as slugs.

The bent portion 8 of the milk conduit is arranged so that slugs created by the slug creating portion 7 travel at an angle upwards into the bent portion 8. The bent portion is further arranged so that the slugs will follow the curvature of the bent portion upwards passing a top portion 8A, further through the bend to the end portion 8B, which end portion is suitably leading the slugs approximately vertically downwards. From the end portion the milk can optionally pass a flow meter 10 before entering the milk container 11.

The sample conduit 9 is positioned in an outer curve portion of the bent conduit between the top portion 8A and the end portion 8B of the bent portion 8. The sample conduit comprises an inlet that is choked 19. The sample conduit is directed at an angle slightly downwards relative a horizontal 20A positioned at the same height as the inlet.

When milk slugs travel through the bent portion 8 they are subjected to acceleration forces. The acceleration forces create a form of virtual gravity, often called centrifugal force, that will force the milk against the outer curve portion and, thus, against the sample outlet. Since air is lighter than milk, air and air bubbles in the milk will travel at the opposite side, thus the arrangement prevents milk with air bubbles from entering into the sample conduit, which would have had an adverse effect on the sample. The choked inlet will dampen a pressure difference between the sample conduit 9 and the milk conduit 8 and prevent sampled milk from returning to the milk conduit 8, even if the relative pressure after a slug passage would suck it backwards.

The sample conduit is directed below the horizontal 20A, but may be close to a horizontal, which lessens the influence of gravity.

Depending on the flow velocity, the curvature of the bent portion 8 is preferably chosen so that the acceleration forces created in milk extracted during milking of an animal is of the same magnitude or larger than the force of gravity.

The acceleration forces acting on the milk increase when the velocity of the milk increases, so that milk is forced stronger into the sample conduit with higher velocity. Therefore, the sampling rate is less dependent on the flow velocity than the branch outlet of the prior art illustrated in FIG. 3, where the gravity is equally strong regardless of flow velocity.

The milk conduit 8 can also be narrowed or tapered, in the flow direction, at the bend. Thus the cross section of the milk conduit 8 at the inlet of the bend is larger than the cross section at the outlet of the conduit, providing a passage having decreasing cross-sectional area. Such tapering increases the flow velocity through the bent portion. The tapering can be linear or curved, e. g. convex.

A preferred embodiment of a milking system comprising means for sampling milk according to the invention has been described. A person skilled in the art realises that this could be varied within the scope of the appended claims.

1. A milking system for extracting milk from an animal and transferring the extracted milk to a container (11), said system comprising:
a milk conduit (5, 6, 7, 8), the milk conduit comprising a bend (8), during flow the bend creating acceleration forces on milk, and;
milk extracting means (2, 3, 4) for attachment to the animal, an outlet of the milk extracting means connected to the milk conduit, the milk extracting means adapted to provide air and milk intermittently into the milk conduit;
a suction source (12) connected to said milk conduit and arranged to provide a vacuum to draw milk from the animal to the container (11); and
a milk sample conduit (9) connected to the bend of the milk conduit,
the sample conduit (9) connected to the bend (8) so as to sample milk subjected to the acceleration forces.

2. A milking system according to claim 1, wherein the sample conduit (9) is connected in an outer portion of the bend of the milk conduit.

3. A milking system according to claim 1, wherein the milk conduit further comprises a milk slug creating means (7) in the flow direction before the bend (8) of the milk conduit.

4. A milking system according to claim 3, wherein the slug creating means is a bended conduit (7).

5. A milking system according to claim 3, wherein the slug creating means (7) is arranged directly before the bend (8) in the milk conduit.

6. A milking system according to claim 1, wherein the sample conduit (9) provides an outlet for sampled milk from the milk conduit, and wherein the sample conduit (9) is directed downwards relative to a horizontal (20A) at an inlet of the sample conduit.

7. A milking system according to claim 1, wherein an inlet of the sample conduit (9) is choked (19).

8. A milking system according to claim 1, wherein the bend (8) of the milk conduit is bent in a vertical plane so that the milk flow passes through a highest positioned top portion (8A) of the bend and continues to a lower positioned end portion (8B) of the bend.

9. A milking system according to claim 8, wherein the sample conduit (9) is connected between the top portion (8A) and the end portion (8B) of the bend in the milk conduit.

10. A milking system according to claim 1, wherein the bend of the milk conduit is fixed so that the bend does not move when the animal moves.

11. A milking system according to claim 1, wherein the sample conduit (9) is connected to a suction source (12) and is arranged to draw milk samples from the milk conduit.

12. A milking system according to claim 1, wherein the milk conduit is tapered, in the flow direction, in the bend (8) so that the bend has a decreasing cross-sectional area in the flow direction.

13. A milking system for extracting milk from an animal and transferring the extracted milk to a container (11), said system, comprising:
a milk conduit (5, 6, 7, 8) comprising a bend (8) shaped so that, during milk slug flow, the bend creates acceleration forces on the milk slugs sufficient that the milk slugs move to an outer curved portion of the bend due to centrifugal force create by the acceleration forces;
milk extracting parts (2, 3, 4) for attachment to the animal, an outlet of the milk extracting parts connected to the milk conduit, the milk extracting parts providing air and milk intermittently into the milk conduit;
a suction source (12) connected to said milk conduit to provide a vacuum to draw milk from the animal; and
a milk sample conduit (9) connected to the milk conduit at the outer curved portion of the bend at a location where the centrifugal force forces the milk slugs against the sample outlet.

14. A milking system according to claim 13, wherein,
the bend (8) of the milk conduit is bent in a vertical plane so that the milk flow passes through a highest positioned top portion (8A) of the bend and continues to a lower positioned end portion (8B) of the bend, and
the sample conduit (9) is connected between the top portion (8A) and the end portion (8B) of the bend in the milk conduit.

15. A milking system according to claim 14, wherein,
the milk conduit further comprises a milk slug creating part (7) located in the flow direction at a location before the bend (8) of the milk conduit, the slug creating part comprising a bended conduit (7) having a region (7a) positioned entirely below a local horizontal surface of the conduit milk conduit (20B).

16. A milking system according to claim 13, wherein an inlet of the sample conduit (9) is choked (19).

17. A milking system according to claim 13, wherein the bend has a decreasing cross-sectional area in the flow direction.

18. A milking system for extracting milk from an animal and transferring the extracted milk to a container (11), said system comprising:
a milk conduit (5, 6, 7, 8) comprising a bend portion (8) having
i) an vertically upward portion, during milk slug flow, causing the milk slugs to travel at an angle upwards further into the bent portion (8), and
ii) an upper top curved portion (8a) connected to an outlet of the vertically upward portion, during the milk slug flow, the milk slugs following a curvature of the upper top curved portion and after passing a topmost part of the upper top curved portion (8A), the milk slugs moving vertically downwards along an outer curve portion of the upper top curved portion due to centrifugal force; and
a milk sample conduit (9) connected to the milk conduit at the outer curved portion of the bend portion at a location where the centrifugal force forces the milk slugs against the sample outlet.

19. A milking system according to claim 18, further comprising:
milk extracting parts (2, 3, 4) for attachment to the animal, an outlet of the milk extracting parts connected to the milk conduit, the milk extracting parts providing air and milk intermittently into the milk conduit; and
a suction source (12) connected to said milk conduit to provide a vacuum to draw milk from the animal, wherein,
the bend portion (8) further comprises a lower positioned end portion (8B), and
the sample conduit (9) is connected between the upper top curved portion (8A) and the end portion (8B).

20. A milking system according to claim 19, wherein,
the milk conduit further comprises a milk slug creating part (7) located in the flow direction at a location before the bend (8) of the milk conduit, the slug creating part comprising a bended conduit (7) having a region (7a) positioned entirely below a local horizontal surface of the conduit milk conduit (20B).
